(19) United States
(12) Patent Application Publication
(10) Pub. No.: US 2004/0044785 A1
(43) Pub. Date: Mar. 4, 2004

(54) Apparatus and methods to select and access displayed objects

(76) Inventors: Cynthia S. Bell, Chandler, AZ (US); Nathan Y. Smith, Scottsdale, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/228,827

(22) Filed: Aug. 27, 2002

(51) Int. Cl. G06F 15/173

(52) U.S. Cl. 709/238

(57) ABSTRACT

Hypertext Markup Language (HTML) objects displayed on a processor-based device are selected for future access and display. In one embodiment, a user positions a cursor over a unique object from a plurality of displayed objects forming an HTML page. The unique object is highlighted, indicating to the user that the corresponding HTML object is selectable. If the user wishes to select the unique object for automatic download of the object, the user can simply mouse-select the object. After the mouse selection, the user may indicate a download interval and a user-friendly object name. The interval, the object name, and an identifier for the object, such as its Universal Resource Identifier (URI) may then be stored for subsequent automatic retrieval of a current instantiation of the object. In some embodiments, recalled objects may be used within other desktop applications or displayed on an appliance, with or without using a Web browser.

### RELATED APPLICATIONS

The present application is related to the following applications, of which all are assigned to the same assignee as the present application, and of which (1) through (3) were filed on even date herewith:

(1) Ser. No. __/______, entitled “User Interface to Facilitate Media File Exchange Among Processor-Based Devices” (Attorney Docket 884.744);

(2) Ser. No. __/______, entitled “Apparatus and Methods to Exchange Menu Information Among Processor-Based Devices” (Attorney Docket 884.745);

(3) Ser. No. __/______, entitled “Network of Disparate Processor-Based Devices to Exchange and Display Media Files” (Attorney Docket 884.746); and

(4) Ser. No. 09/561,054 entitled “Enabling Hypertext Elements to Work with Software Applications”.

### TECHNICAL FIELD

Embodiments of the present invention relate generally to processor-based devices and, more particularly, to apparatus and methods to select and subsequently access information from a network.

### BACKGROUND INFORMATION

An HTML page, such as an Internet Web page, may display one or more objects. Some Web page content is static, while other content is dynamic and can change over time. Web page content can comprise many different types of objects, including but not limited to text, graphics, still images, moving images, and audio. In many cases, a user would like to access objects that have a time-varying content. Examples include Web camera (Webcam) views, stock quotes, time and temperature readings, and many other types of time-varying content. However, generally to gain access to such Internet content, a substantial amount of user involvement is required. The user generally must operate a computer and manually browse to a Web page of interest. In other cases, the user may subscribe to a service, wherein various information can be emailed or downloaded to the user, e.g. a breaking news story, a stock quotation, or the like.

Known information delivery service employ a so-called “walled garden” approach, restricting the set of Web sites to which subscribers can retrieve information, leaving the rest of the Web inaccessible.

In a number of cases, this subscription service is not particularly easy to use and presents a significant cost barrier to users. Thus, there is a need for a more intuitive and less costly way to select and schedule a desired object download. In addition, many processor-based devices have relatively limited capabilities. These limited capabilities are manifested in a variety of ways. Some processor-based devices contain limited input/output elements, such as telephone keypads and/or tiny display screens. Other processor-based devices may have relatively limited processing and/or memory capabilities. A processor-based device of relatively limited resources may be referred to herein as a “processor-based appliance”, a “digital appliance”, an “electronic appliance”, or simply an “appliance”.

It is known that appliances can communicate with a remote server, e.g. through a dial-up wired connection, so that digital media can be downloaded to the appliance at periodic intervals. Examples of such appliances include a digital picture frame (DPF), a digital music player, and a personal digital assistant (PDA). Also, Internet-capable cellular telephones can communicate with a remote server through a wireless connection through a nearby cellular base station to retrieve digital media.

In many situations involving processor-based devices having relatively limited resources, conventional download software and/or hardware may provide sub-optimal performance and may be relatively difficult and awkward to use.

Thus, there is a need for better and more user-friendly ways to retrieve network information, such as Internet Web objects.

### BRIEF DESCRIPTION OF THE DRAWINGS

FIG. 1 illustrates a front perspective view of a computing device to implement one or more embodiments of the present invention;

FIG. 2 illustrates a conceptual block diagram of at least one embodiment of the present invention;

FIG. 3 illustrates a block diagram of a processor-based device coupled to a local network and/or a wide-area network, and that implements one or more embodiments of the present invention;

FIG. 4 illustrates a depiction of a Web browser window displaying a Web page containing a Webcam view, in accordance with an embodiment of the present invention;

FIG. 5 illustrates a depiction of the Web browser window shown in FIG. 4 after a device user has hovered a cursor or pointer over a Web page object, in accordance with an embodiment of the present invention;

FIG. 6 illustrates a depiction of the Web browser window shown in FIG. 5 after a device user has selected a particular Web page object, in accordance with an embodiment of the present invention;

FIG. 7 illustrates a depiction of the Web browser window shown in FIG. 6 after a device user has selected a download interval, in accordance with an embodiment of the present invention;

FIG. 8 is a flow diagram illustrating an exemplary method to select an HTML object, in accordance with one or more embodiments of the present invention; and

FIG. 9 is a flow diagram illustrating a method to automatically retrieve an HTML object at a desired time interval, in accordance with one or more embodiments of the present invention.

### DETAILED DESCRIPTION OF EMBODIMENTS OF THE INVENTION

In the following detailed description of embodiments of the invention, reference is made to the accompanying drawings that form a part hereof, and in which is shown by way of illustration, but not of limitation, specific embodiments of the invention. These embodiments are described in sufficient detail to enable those skilled in the art to understand and implement them, and it is to be understood that other embodiments may be utilized and that mechanical, structural, logical, electrical, and procedural changes may be made without departing from the spirit and scope of the present disclosure. The following detailed description is, therefore, not to be taken in a limiting sense, and the scope of embodiments of the present invention is defined only by the appended claims.

In the Related Application (4) entitled “Enabling Hypertext Elements to Work with Software Applications”, a processor-based device coupled to the Internet provides a software-implemented mechanism for a device user to determine which of one or more applications running on the device can automatically store relevant information appearing on a Web page in the form of a hypertext element. For example, if the device user is viewing a restaurant's Web page, and if the device user has previously registered an address book application with hypertext extraction software residing on the user's device, the user can indicate or command, at the user's option, that a displayed restaurant address be stored in the user's address book application.

In embodiments of the present invention, a device user is able to select a particular object being displayed, if the device user desires that the particular object be automatically retrieved in the future. The information retrieved in the future can represent updated information, and it is not limited to a static one-time instantiation of the object. The device user is able to easily customize the specific type of information to be downloaded in the future. The information can be a subset, e.g. a frame or one or more other objects, from a larger organizational unit, e.g. a Web page or, more generally speaking, a page from a tag-based language or tag-based structure that is accessible from computer local storage or from a network, thus facilitating the display of the information on processor-based devices or appliances having relatively limited resources.

The terms “displayed” or “rendered”, as used herein, include any kind of human-perceivable performance.

The term “object”, as used herein, means a portion or component of information generated using a tag-based language such as HTML or using a more general tag-based structure, such as a combination of protocol and language. An example of such information is an HTML or Web page that is accessible from a computer or network such as, but not limited to, the Internet. For example, a displayed Web page may comprise a plurality of objects. The objects may be of many different types and may be of any size. Examples of objects include, but are not limited to, frames, sub-frames, images or series of images, video, and sounds.

In one embodiment, an object can be retrieved at a user-defined time interval. For example, a Webcam view or the current temperature could be retrieved every 5 minutes or at another user-designated interval. Whatever kind of information the retrieved object may contain, it is the latest instantiation of the contents of a selected object.

In one embodiment, the retrieved information may be used, if desired, in another application residing in the user's device. The retrieved information does not necessarily have to be utilized by a browser on the user's device.

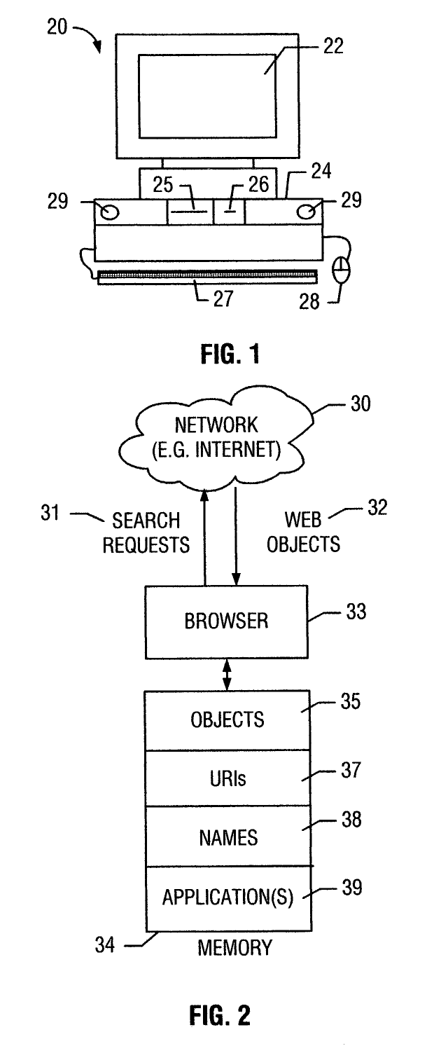

FIG. 1 illustrates a front perspective view of a computing device 20 to implement one or more embodiments of the present invention. Computing device 20 may be or include a personal computer 24 or any other processor-based device. Computing device 20 may include a display 22 in accordance with one embodiment. Computing device 20 may include one or more removable media slots, such as floppy disk slot 25 and memory card slot 26. Computing device 20 may also include a keyboard 27, a pointing device such as mouse 28, and/or any other selection device or element that permits a device user to input information into and receive information from computing device 20. Computing device 20 may include one or more speakers 29.

Many other types of processor-based devices or computing devices 20 may be used to implement one or more embodiments of the present invention. These include any devices that can access a network, such as the Internet, that contains sources of information arranged in a tag-based language or structure, such as HTML. Such devices may take the form of a computer (e.g., desktop, laptop, hand-held, etc.), a wireless communications device (e.g., cellular phone, 2-way pager, etc.), a digital picture frame, a personal entertainment device (e.g. a radio), audio-visual equipment, a personal digital assistant, Internet appliance, electronic book, and the like.

FIG. 2 illustrates a conceptual block diagram of at least one embodiment of the present invention. Utilizing a Web browser 33 or other suitable network search engine, a device user can send a search request 31 for a Web object to a remote resource (not shown) coupled to the network 30. The remote resource can be for example, a computing device or server on a local area network, a wide area network, an intranet, the Internet, the World-Wide Web (“WWW” or “Web”), or any other network.

“Suitable”, as used herein, means having characteristics that are sufficient to produce the desired result(s). Suitability for the intended purpose can be determined by one of ordinary skill in the art using only routine experimentation.

A brief discussion of how Web objects are identified and retrieved on the Web may aid the reader's understanding at this point. As is well known to those of ordinary skill in the art, the Web utilizes an agreed-upon syntax, which can include one or more standards, to encode the addresses and/or names of objects stored in computers coupled to the Web. Under one such standard, access instructions for individual objects can be encoded into forms of address strings. According to another standard, objects can be defined or encoded according to object names. Thus, to accommodate the concept of a generic Web object, the Web accepts the notion of a universal set of objects, and of a universal set of addresses or names of objects.

A Universal Resource Identifier (URI) is a member of this universal set of addresses or names. A URI represents source information or a pathway to the location of a particular object in the Web.

A Universal Resource Locator (URL) is a type of URI that encodes an object's location using an object address.

A Universal Resource Name (URN) is another type of URI. A URN encodes an object's location using a persistent object name.

Examples of some known Web standards include Extensible Markup Language (XML), Hypertext Markup Language (HTML), HyperText Transfer Protocol (HTTP), and File Transfer Protocol (FTP).

XML is a Web language that is maintained by the XML Working Group of the World Wide Web Consortium. XML is part of a more general and complex Standard Generalized Markup Language (SGML). SGML is a standard of the International Organization for Standardization (ISO) based in Geneva, Switzerland. SGML defines descriptions of the structure of different types of documents and other electronic information.

HTML is another Web language within SGML. HTML defines how HTML and Web pages are stored, formatted, processed, and displayed. HTML utilizes a variety of control characters called tags. The tags are embedded within a file in order to determine how text, images, sounds, links, and other objects are displayed in a Web document.

HTTP is a Web protocol. HTTP defines how objects are formatted and transmitted, and what actions Web servers and browsers should take in response to various commands. As an example, when a URI is entered into a browser, an HTTP command is transmitted to a Web server directing it to fetch and transmit the requested Web page or object to the requesting computing device.

Various known software and software technologies, such as ActiveX™, Java™, and JavaScript™, can also be used to define, manipulate, transmit, and display Web objects. ActiveX is available from Microsoft Inc. of Redmond, Wash. Java and JavaScript are available from Sun Microsystems Inc. of Palo Alto, Calif.

Although the above-described standards are the most widely known Web standards, embodiments of the present invention are not limited to these standards, nor are embodiments of the present invention limited to URIs, but rather embodiments of the present invention can be utilized with any network protocol or language and with any type of data identifier.

Returning now to the discussion of FIG. 2, the device user's search request 31 can comprise a URI, such as a URL or other type of object retrieval string (ORS), runtime object identifier, data identifier, Internet pathway, or the like. A URL typically comprises four parts: a protocol type (e.g. http:// or ftp://), a host name or server name (e.g. abcd.com), a path name or sub-directory (e.g. /efgh/info/), and a file name (e.g. ijkl.html). The file name can include a file type, which is usually indicated by the filename extension (e.g. “text/html”, “image/gif”, etc.). An optional part of a URL is a query string preceded by “?” or a “fragment identifier” preceded by “#”. A fragment identifier can indicate a particular position within the specified document.

Still referring to FIG. 2 and the operation of Web browser 33, in response to a search request 31 sent to network 30 by Web browser 33, a desired Web object 32 satisfying the search request 31 is returned to Web browser 33.

As mentioned earlier, an HTML page (e.g. a Web page) can comprise a plurality of objects. The objects can represent any kind of information and be of any size (e.g. down to a pixel).

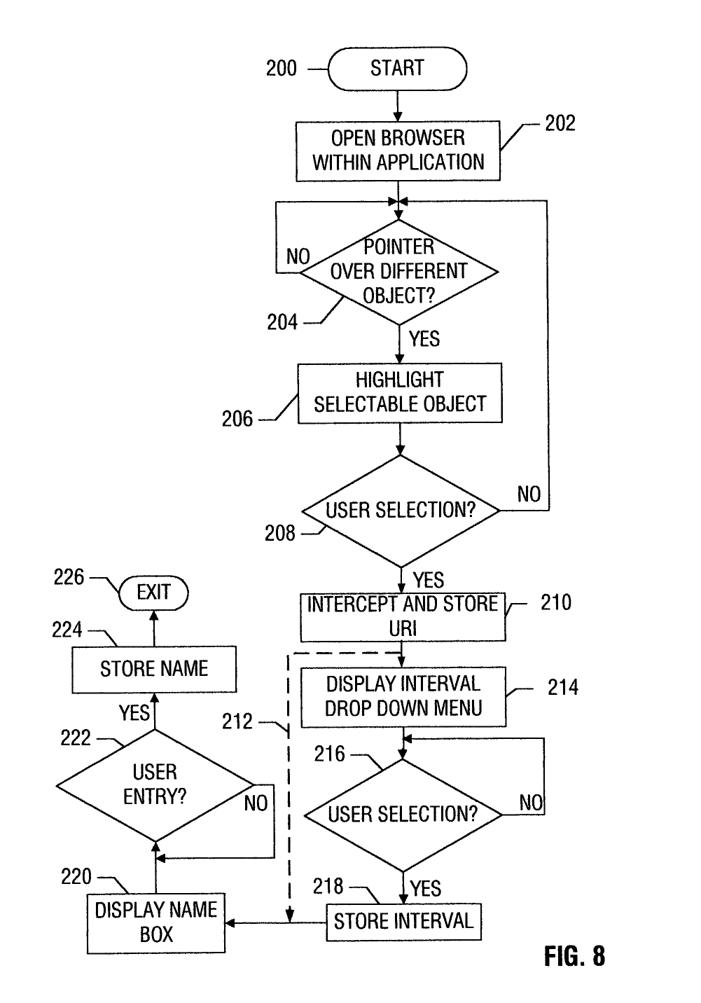

Through at least one mechanism described herein (refer to the exemplary method described with reference to FIG. 8), a device user can select a desired Web object for future access, display, and/or use. This process involves minimal effort on the part of the device user, and it does not require the device user to remember or record a lengthy object descriptor in order to access, display, and/or use the desired object at a future time. The device user can assign a user-friendly name to the desired object that facilitates retrieval.

When the device user has selected the desired object, sufficient attributes to again retrieve it are stored in memory (e.g. the local memory of the user's computing device, or alternatively in a network computer). The retrieval attributes can be stored in any suitable manner, for example in a database. The database could include, for example, the URI (e.g. a URL) and user-assigned name for each stored object. Other storage schemes could be used in other embodiments.

Memory 34 of an exemplary computing device (e.g. computing device 20, FIG. 1) can comprise various stored objects 35. Still referring to FIG. 2, one or more objects 35 can be stored in any suitable type of memory 34 (e.g. random access memory (RAM), a hard drive, and/or in a video display memory) in order that they can be displayed on the computing device's display (e.g. display 22, FIG. 1).

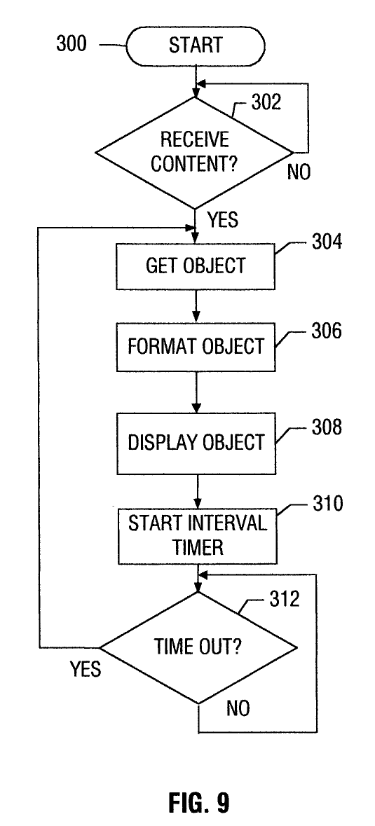

Still referring to FIG. 2, memory 34 can also comprise a database of URIs 37 and user-assigned names 38. In addition, memory 34 can include one or more software applications 39, including an application to implement the exemplary methods discussed below regarding FIGS. 8 and 9.

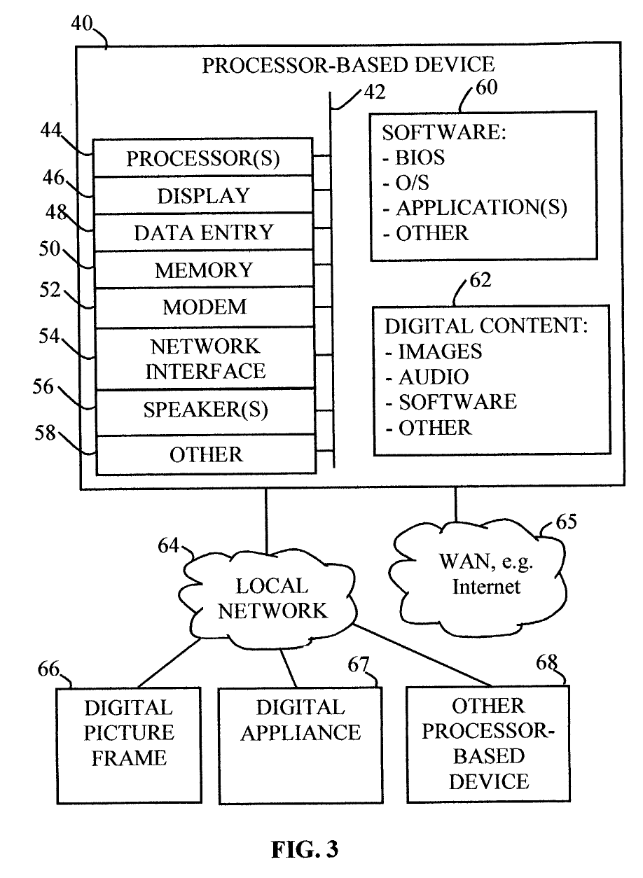

FIG. 3 illustrates a block diagram of a processor-based device 40 coupled to a local network 64 and/or a wide-area network 65, and that implements one or more embodiments of the present invention. FIG. 3 and the following discussion are intended to provide a brief, general description of a suitable computing environment in which certain embodiments of the present invention may be implemented.

Thus, an exemplary system to enable displayed objects to be selected and accessed in the future includes a machine or processor-based device 40 having system bus 42. Processor-based device 40 is merely one example of a computing system in which embodiments of the present invention can be used. In this example, processor-based device 40 comprises a data processing system that includes a system bus 42 to couple the various components of the system. System bus 42 provides communications links among the various components of the processor-based device 40 and can be implemented as a single bus, as a combination of busses, or in any other suitable manner.

Attached to bus 42 are typically one or more processors 44, a display 46, and one or more data entry elements 48 such as a keyboard, mouse, trackball, joy stick, touch-sensitive screen, or the like. Also attached to bus 42 is a memory 50, which can include any suitable memory device(s) like read only memory (ROM); random access memory (RAM); hard drive; removable media drive for handling compact disks (CDs), digital video disks (DVDs), diskettes, magnetic tape cartridges, memory sticks, memory cards, and other types of data storage; or the like. Additional elements can also be attached to bus 42 such as a modem 52, a network interface unit 54, one or more speakers 56, and other suitable devices 58.

As used herein, “processor” means any type of computational circuit such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), or any other type of processor or processing circuit. The term also includes embedded controllers, such as Generic or Programmable Logic Devices or Arrays, Application Specific Integrated Circuits, single-chip computers, smart cards, and the like.

Processor-based device 40 can also include a plurality of types of software programs. For example, processor-based device 40 can comprise software 60 that includes a basic input/output system (BIOS), operating system (O/S) software, one or more software applications, and any other types of software as required to perform the operational requirements of processor-based device 40.

Processor-based device 40 can also include a plurality of types of digital content 62. For example, processor-based device 40 can comprise digital content 62 that includes images (both still and moving), text, audio, computer software, and any other types of digital content.

Processor-based device 40 can operate in a networked environment using physical and/or logical connections to local network 64 and/or wide area network (WAN) 65. The connections to these networks can be wired and/or wireless.

Local network 64 can comprise any number or type of computing devices, such as a digital picture frame 66, digital appliance 67, or any other processor-based device 68 such as those mentioned elsewhere herein. Other processor-based devices on local network can include, but are not limited to, music jukeboxes, radios, set-top boxes, digital televisions, and the like. Digital picture frames are described in greater detail in Related Applications (1) to (3).

WAN 65 can be any type of network that is greater in scope than local network 64. In one embodiment, WAN 65 comprises the Internet. In another embodiment, WAN 65 could comprise an intranet.

Embodiments of the invention may be implemented in conjunction with program modules, including functions, procedures, data structures, application programs, etc. for performing tasks, or defining abstract data types or low-level hardware contexts. Program modules may be stored in memory 50 and associated storage media, e.g., hard drives, floppy disks, optical storage, magnetic cassettes, tapes, flash memory cards, Memory Stick™ devices, digital video disks, chemical storage, and/or biological storage. Program modules may be delivered over transmission environments, including networks 64 and 65, in the form of packets, serial data, parallel data, propagated signals, or in any other suitable manner. Program modules may be used in a compressed or encrypted format, and they may be used in a distributed environment and stored in local and/or remote memory, for access by single and multi-processor machines, or any other type of processor-based device 40.

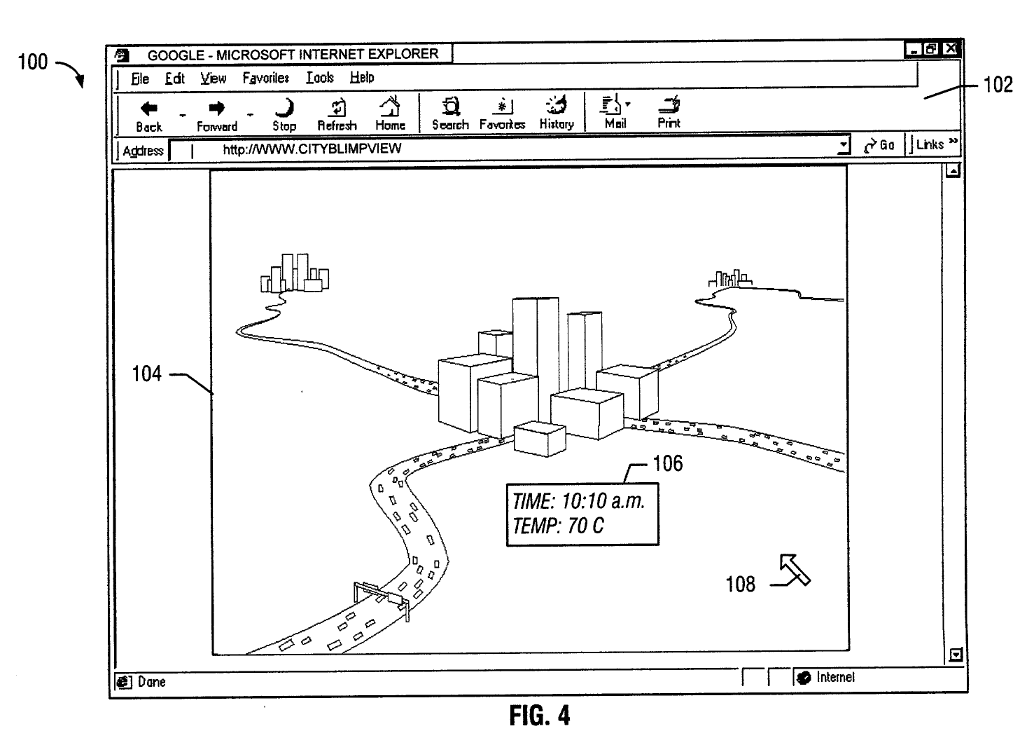

FIG. 4 illustrates a depiction of a Web browser window 100 displaying a Web page 104 containing a Webcam view, in accordance with an embodiment of the present invention. Web page 104 is merely one exemplary HTML page that could potentially be viewed on a network such as the Internet.

Web browser window 100 depicts a typical graphical user interface (GUI) that is currently offered by an Internet browser such as Internet Explorer™ available from Microsoft Inc. of Redmond, Wash. Web browser window 100 comprises a number of different objects In this example, one type of object, namely frames, will be discussed, but it will be understood by those skilled in the art that objects are not limited to frames.

Web browser window 100 can be made up of a number of frames. For example, one frame can be a browser menu 102 the details of which are not particularly relevant to embodiments of the present invention. Another frame (not shown) could be an advertisement. Another frame (not shown) could include contact information, such as a phone number, address, etc. Another frame (not shown) could be a menu (separate from browser menu 102) that is associated with a Web page currently being displayed. For example, a menu (not shown) could list various viewpoints of city traffic.

Web browser window 100 can also include a central frame 104. In this particular example, central frame 104 depicts cityscape traffic as viewed from a video camera coupled to a Webcam situated, for example, in a blimp or on a nearby mountain.

Within central frame 104 is a smaller Web frame 106, in which the current time and temperature are displayed. A cursor or pointer 108, which can be moved by a device user using a suitable selection element or pointing device, is also depicted near Web frame 106.

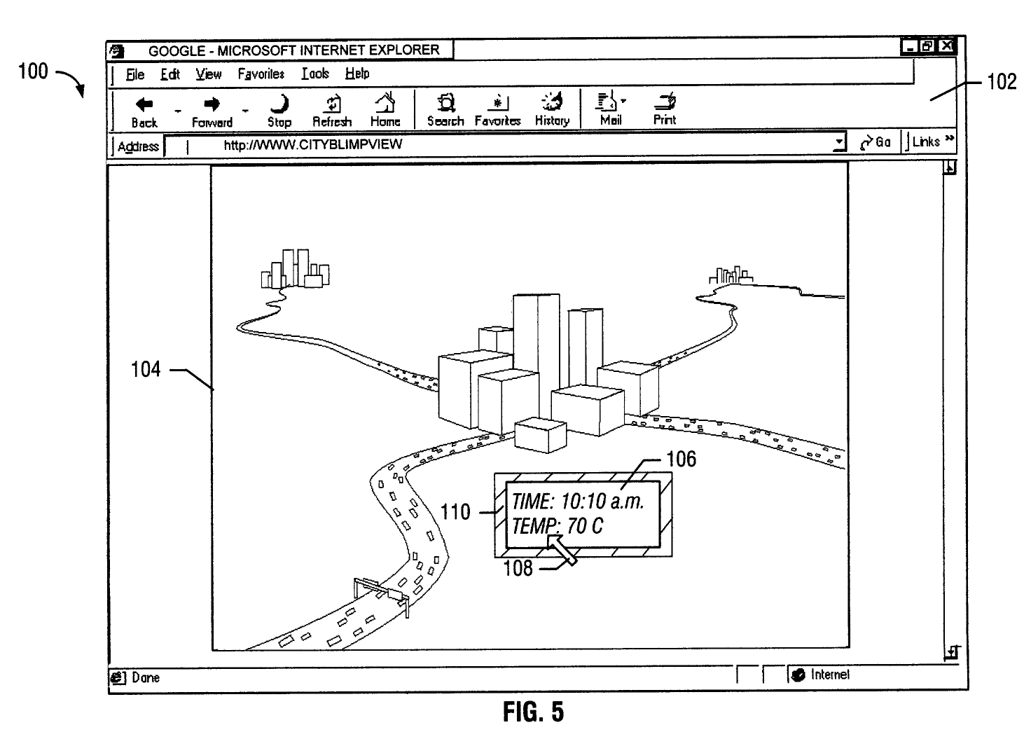

FIG. 5 illustrates a depiction of the Web browser window 100 shown in FIG. 4 after a device user has hovered a cursor or pointer 108 over a Web page object, such as Web page frame 106, in accordance with an embodiment of the present invention. As pointer 108 is moved to overlie Web frame 106, the visual appearance of Web frame 106 is altered to inform or cue the device user that he or she has focused attention on Web frame 106. The visual appearance of Web frame 106 can be altered in any suitable manner. In the particular embodiment shown in FIG. 5, a colorful border 110 can surround Web frame 106. Alternatively, a sound or tonal sequence could cue the device user. The user-cuing function is explained in greater detail below in the description of FIG. 8. Regarding the generation of border 110 in FIG. 5, a suitable HTML object selector application receives event input from the browser window, and it subsequently edits a local instance of the Web page's Cascading Style Sheet (CSS) to add a new border 110.

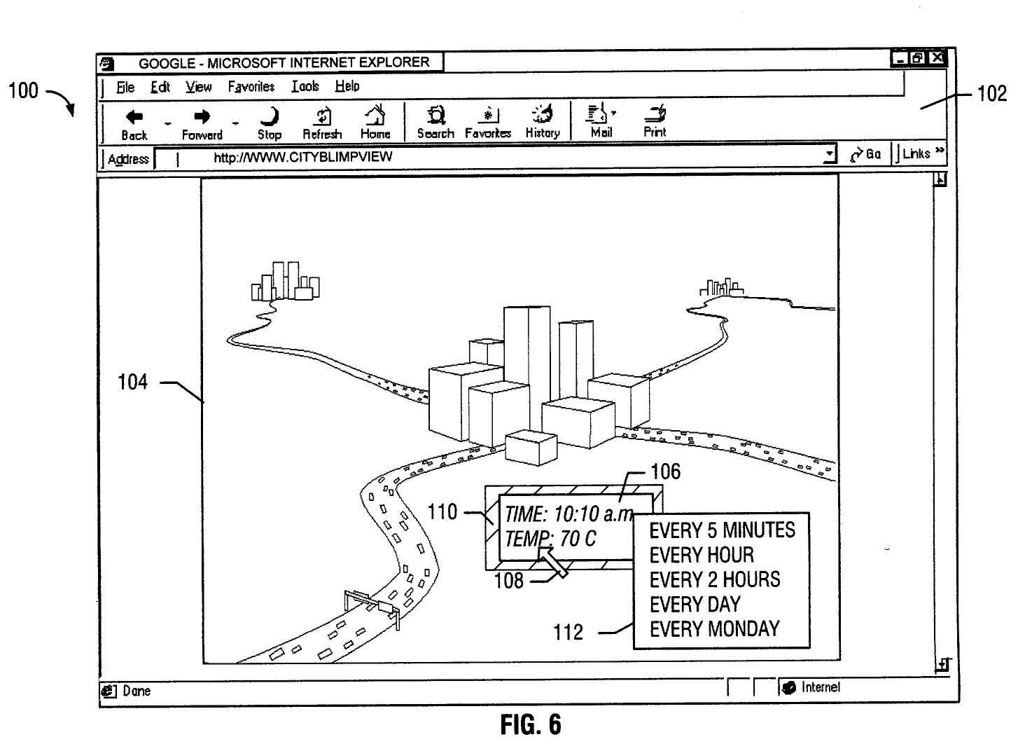

FIG. 6 illustrates a depiction of the Web browser window 100 shown in FIG. 5 after a device user has selected a particular object, namely Web page frame 106, in accordance with an embodiment of the present invention. The device user can select the particular object that he or she is focusing on. The select operation can be initiated, for example, by the device user clicking a mouse button while hovering a pointer 108 over the object, such as Web frame 106.

In response to the device user's selection of the object, all relevant information necessary to subsequently access and display object is captured and stored, e.g. in the computing device's local memory, as will be explained further regarding FIG. 8 below.

Optionally, in response to the device user's selection of an object, such as Web frame 106, a pop-up window or menu 112 can be displayed to the device user, indicating a number of alternative time intervals or download times (not necessarily periodic) at which the Web frame 106 can be subsequently retrieved from the network and displayed on the user's computing device, stored within the computing device, or otherwise used by one or more applications controlling the computing device.

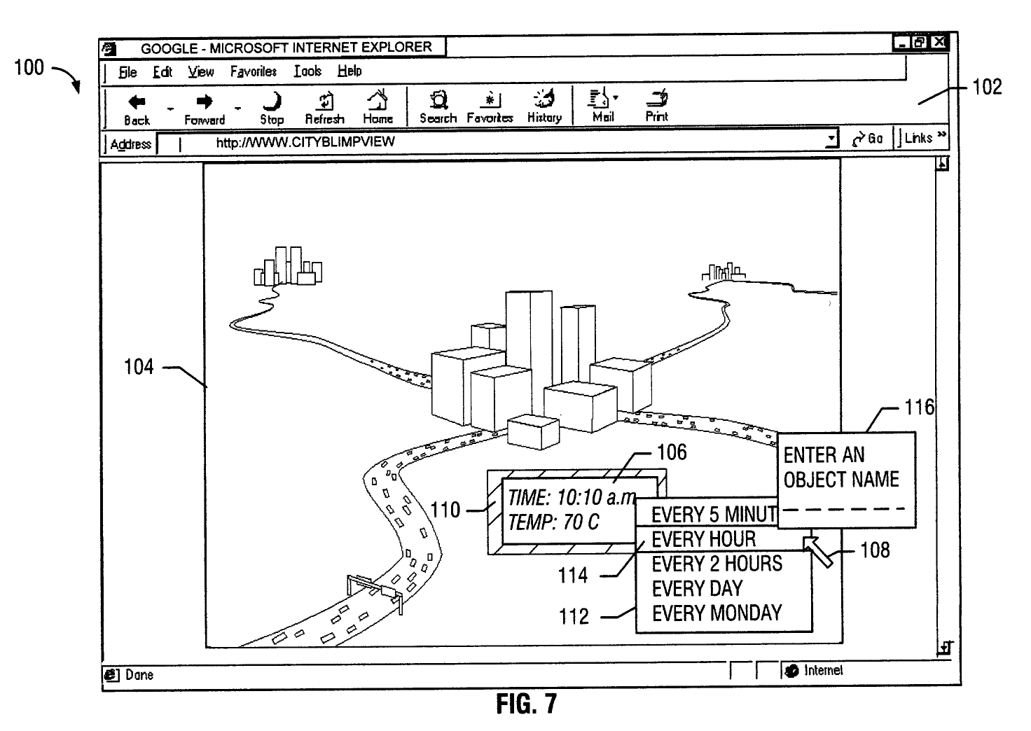

FIG. 7 illustrates a depiction of the Web browser window 100 shown in FIG. 6 after a device user has selected a download interval, in accordance with an embodiment of the present invention. In response to the device user's selection of a content item 114 (e.g. “Every Hour”), a pop-up window 116 can be displayed to the device user, allowing the device user to enter a user-assigned friendly name or “handle” for the object as a mnemonic aid in subsequently retrieving the object. After the device user has entered a user-friendly name into pop-up window 116, the device user can finish the operation in a suitable manner, e.g. by depressing the “Enter” key (not shown) or by clicking the pointer on an “Enter” button (not shown).

It will be understood that the example shown in FIGS. 4-7 is merely one of many possible examples. For example, a device user could schedule a favorite television show to be shown, or a favorite radio program to be played, either live or time-shifted. Media content of any type could be selected for later retrieval.

FIG. 8 is a flow diagram illustrating an exemplary method to select an HTML object, in accordance with one or more embodiments of the present invention.

In 200, the method starts. To set up automated retrieval of an HTML object for future access, a user runs an application on his or her computing device, which is assumed to have access to at least one tag-based structure, such as an HTML page, located on a remote resource. In one embodiment, the application is an HTML object selector application. As indicated elsewhere, embodiments of the invention can work with information residing on any type of remote resource on any type of network, including a LAN, or a WAN such as the Internet.

In 202, once the HTML item selector application is running, it launches a Web browser. Opening a Web browser within the HTML item selector application enables the application to utilize operating system (e.g. Microsoft Windows™ operating system, available from Microsoft, Inc., Redmond, Wash.) commands to “hook” into the browser. Hooks that indicate low-level user activity, such as a change in cursor on-screen coordinates or a mouse click event, are used to automate the task at hand. Appropriate Windows operating system (OS) commands or their equivalents are available. It will be readily appreciated by those skilled in the art that it is also possible to write drivers for the mouse and keyboard that offer such information hooks in case that they are not otherwise available for the particular OS being used.

Once the browser is running inside the application, the device user may browse the network (e.g. the Internet) to an HTML page with information that he or she desires to automate item retrieval from. The device user then indicates by means of the application's graphical user interface (GUI) that this is the particular HTML object that he or she wishes to obtain content from. Note that the device user may browse through many pages before reaching one that holds information of interest.

In one embodiment, the device user hovers a cursor over an object (e.g. a frame) of interest. The object is highlighted, for example through a change in appearance, such as a colored or flashing border, inverse video, change in intensity or color, sound, or the like. This provides suitable feedback to the device user that he or she is viewing the desired object. The device user can then select the desired object, e.g. by clicking on it with the mouse. This causes an object retrieval string (ORS) for the desired object to be intercepted and stored. The ORS may include a first identifier (e.g. a URI) to locate the unique HTML page on the remote resource, and a second identifier to locate the desired object within the HTML page.

The device user is then given an opportunity to assign a user-friendly name to the object. Optionally, the device user can also be given an opportunity to indicate specific times (e.g. at 10 a.m. and 4 p.m.) or a time interval (e.g. every 5 minutes) for the object to be retrieved on the user's computing device. The object can be displayed either synchronously or asynchronously with the object retrieval interval.

The above-described operations will now be described regarding 204-226 of FIG. 8.

In 204, the position of the user-controlled pointer or selection element is determined with respect to an HTML object being displayed. It is assumed for the purposes of this example that an HTML page being displayed comprises several separate objects. If the pointer is moved, a determination is made whether the pointer is over (or proximate to) a different object. If so, the method goes to 206; if not, it loops back to the beginning of 204.

In 206, the selectable object is highlighted in a suitable manner, as mentioned in the summary above. The HTML page object corresponding to the current pointer position is determined from the local copy of the page's HTML code. Objects usually have position coordinates or descriptors associated with them that are used to describe how the page is to visually be constructed. Thus, using the current pointer position, the associated object can be identified, and that object is then highlighted.

The term “highlight”, as used herein, means providing any type of sensory feedback to a device user. For example, highlighting can include by way of example, but is not limited to, a change in visual appearance, such as a colored or flashing border around the object, inverse video, change in intensity or color, change in the font size, or the like. Highlighting can also include an audio signal or a change in an audio signal.

In one embodiment, the application performs highlighting by appending a highlighting command string in the local copy (i.e. the copy on the user's computing device) of the HTML page's Cascading Style Sheet (CSS). The CSS string tells the browser how to highlight the object, e.g. with an alternating blue and green flashing border.

In 208, a determination is made whether the device user has selected the object. If so, the method goes to 210; if not, it goes back to 204. At 208, the application waits for either a mouse click, or for new pointer or cursor screen coordinates. When the pointer position moves off of the current Web frame (i.e. takes the “NO” branch back up to 204), the application removes the highlighting command for that object from the CSS, and at 206 the application enters the highlighting command for the new object corresponding to the new pointer position. If the pointer is hovering over the same object as in the previous iteration, no change is needed or made. When the device user selects the highlighted object and generates an actuation signal, for example by clicking a mouse, the “YES” branch is taken to 210.

In 210, the URI for the source of the Web frame is intercepted and stored. In one embodiment, the properties of the selected object are returned with the browser event regarding the mouse click. The properties are examined, and the object's retrieval string is determined by examining the object's properties and URI. The URI (e.g. a URL) defines the location of the source of information (e.g. on the Web or other network) that is used to populate the object at each instantiation. The URI or other pathway back to the source of the object within the network is saved.

In some cases, the selected object may have an author-defined identifier (ID) that readily identifies the object within the target page without having to look further within the code (e.g. HTML code) that defines the particular displayed page.

At this point, the method can proceed directly to 220 (skipping 214, 216, and 218), or it can optionally proceed to 214.

In 214, a menu of display interval choices can be presented to the device user (e.g., refer to menu 112, FIGS. 6 and 7). The menu could be a drop-down, pop-up, or any other suitable menu or input mechanism.

In 216, a determination is made whether the device user has indicated a display interval selection yet. If so, the method goes to 218; if not, it loops back to the beginning of 216.

In 218, the device user's choice of display time(s) or interval is stored. In 1 5 another embodiment, the length of a refresh interval or update interval could be set automatically. For example, it could be determined by the information type (weather reports could be displayed daily; stock reports could be displayed hourly; etc.), or by the type of computing device (e.g. a digital picture frame displaying a favorite vacation scene could be updated daily). Applications may utilize the object retrieval capability at an interval that makes sense for their purpose. For example, a Webcam feed application for a DPF could access the Webcam every 5 minutes and send the data across the LAN to the DPF.

In 220 (which can be arrived at either directly from 210 or from 218), a data entry window or box is displayed in which the user is to enter a user-friendly name for the desired object. This name facilitates subsequent retrieval of the desired object, because it doesn't require the device user to memorize or write down a lengthy URI or URL. For example, if the desired object is the current time and temperature, the device user could enter “TIME&TEMP”, “TT”, or any other short-cut phrase that is solely of the device user's choice. The user-friendly name should be unique on the user's computing device.

In 222, a determination is made whether the user has yet entered a user-friendly name for the desired object. If so, the method proceeds to 224; if not, it returns to the beginning of 222.

In 224, the user-friendly name is stored. This is the name that will be visible in menus for retrieval at any time. The device-user-assigned name can be saved in a database along with the object retrieval string, URI, and any other relevant information, such as an object author identifier. As a result, the selected object may be repeatedly downloaded through the stored information. In embodiments of Related Applications (1) through (3) above, a user-friendly name can be used not only on host computing devices, such as personal computers, but it can be sent as a menu item to a digital picture frame, computing appliance, or other type of processor-based device that is in wired or wireless communication with a host computing device, in order to facilitate user manipulation and selection of media files of interest.

At 226, the method ends. This completes one embodiment of an automated object retrieval definition process. The device user may exit the application now or loop back to set up an automated object retrieval to another HTML page object. It will be understood that while an “end” block 226 is shown in FIG. 8, the method can be performed continuously.

FIG. 9 is a flow diagram illustrating a method to automatically retrieve an HTML object at a desired time interval, in accordance with one or more embodiments of the present invention. This method, or a similar embodiment, can be used by a user's computing device to retrieve and, if desired, display or otherwise render a desired HTML page object. Object retrieval may occur whenever requested by the calling device. It can occur periodically on a regular basis, or it can occur only once or sporadically.

When regular retrieval of the object begins (i.e., the library is instantiated), the downloading process is not initially started. By calling a function in the library that selects the object “stream” to be downloaded, the download can be initiated once or at desired intervals or times.

In each download, the most current instantiation of the object is retrieved for use by the calling device. The Object Retrieval String (ORS) specifies the Web server that sources the selected object.

For an image, the URL of the object will have an attribute, the source (“SRC”). Within the SRC is the ORS property of the image. The URL points to the HTML page on which the user found the object, but the URL need not be retrieved. Rather, the image can be fetched from its source server.

The ORS can be used to perform an HTTP “GET” of the object and thus to download the current instantiation of the object to the calling device. The request for this content is immediately transmitted back to the host computer. The host computer receives the latest version of the HTML object from the network (e.g. the Internet) and may also relay it to the appliance.

An appliance user may essentially view a Webcam broadcast real-time on his or her appliance. In this specific use of the software, the image may be resized before being transmitted to the device, so that the entire image is displayed. Thus, an appliance can become a virtual display of a favorite vacation spot, Webcam view, etc.

Additionally, if the object is a non-binary HTML element, the HTML of the element can be retrieved. In this case, an invisible browser instance is started, so that the HTML object may be accessed and returned to the calling function.

The above-described operations will now be described regarding 300-312 of FIG. 9.

In 300, the method starts. In 302, a determination is made whether the device user has selected the friendly name of a retrieval item from a menu of possible choices. If so, the method goes to 304; if not, it returns to the beginning of 302.

In 304, the desired object is retrieved, assuming the user's computing device is operatively coupled to a network (e.g. Internet), utilizing information stored in the computing device, such as an object retrieval string and URI. In one embodiment, the computing device executes an HTML command from a suitable application 39 (FIG. 2) that supports Object Linking and Embedding (OLE) and/or Component Object Model (COM), such as an ActiveX application, available from Microsoft, Inc. of Redmond, Wash. In another embodiment, the computing device executes an FTP command, a Java command, or a JavaScript command.

It will be appreciated by those of ordinary skill in the art that the desired object may have one or more other objects that are linked to or associated with it. For example, a graphic, photo, or video object may have an associated audio file. In the most general sense, any type of object can be associated with any one or more other types of HTML objects. The device user's selection of an object can thus result in the retrieval and execution of more than one HTML object on the user's computing device.

In 306, the object is formatted, as necessary, for display on the user's computing device. For example, a Joint Photographic Experts Group (JPEG) file could be converted to a bit-mapped file. As another example, a QuickTime™ file could be converted to a RealPlayer™ file. If more than one type of HTML object was retrieved (e.g. a photo file and an audio file), each may be reformatted, as necessary, to be displayed or played back on the appropriate display, loudspeaker, and/or other output element(s) of the user's computing device.

It may be desirable to resize, reconfigure, or otherwise alter the object to be displayed. For example, it may be desirable to change the image size and fonts of a text object. For example, the time and temperature information displayed in Web frame 106 (FIG. 7) might be displayed in a larger size or in a preferred color. The object parameters could also be altered in order to accommodate the transfer of the object to a processor-based device having a different (e.g. smaller or larger) resolution.

In 308, the object, and any associated object(s), are displayed or rendered on the computing device. As mentioned above, the terms “displayed” and “rendered” include any kind of human-perceivable performance. It should be understood that it is possible, but not necessary, to display the object using a Web browser. The object can be displayed without opening a Web browser, e.g. using a display application on a digital picture frame. The retrieved object could also be utilized in any other type of application, such as a digital media manipulation application, for example Adobe Photo Shop™ or Adobe Photo Deluxe™ available from Adobe Systems Inc. of San Jose, Calif.

It will be appreciated that the object, and any associated object(s), can be stored directly on the computing device of the requesting user, and that they do not have to be fed to a browser. In one application, all content that is downloaded during a specific interval could be viewed and/or listened to by a device user. For example, a device user could view all Webcam views of a home nursery, or listen to a play list of all songs broadcast on a particular Web station, during a time interval. To conserve storage space, files could be automatically deleted on a regular basis.

Operations 310 and 312 are optional and can be utilized to display the desired object at a given time interval.

In 310, an interval timer is started, and the method goes to 312.

In 312, a determination is made whether the time interval has timed out. If so, the method loops back to 304, where a new instantiation of the object is retrieved without human involvement, and the method again sequences through 306 and 308 to 310. If the time interval has not yet timed out, the method returns to the beginning of 312.

The operations described above with respect to the methods illustrated in FIGS. 8 and 9 can be performed in a different order from those described herein.

Conclusion

Embodiments of the present invention provide a resource to select HTML objects, including Web objects, for future retrieval and display on a computing device. A selected HTML object can be a subset of all of the objects that make up a browser's screen display. By enabling a device user to select and retrieve an object that the device user is primarily interested in, resource requirements are minimized.

This is important, for example, in an embodiment in which the selected HTML object is to be retrieved for display on a processor-based device with minimal or reduced resources. Examples include digital picture frames, Internet phones and pagers, palm-top computers, radios, audio-visual equipment, and other processor-based devices. Selected HTML objects can be updated at user-determined intervals without user involvement, by using the software-implemented methods of embodiments of the present invention, thereby making these types of processor-based devices more commercially attractive.

As shown herein, the present invention can be implemented in a number of different embodiments, including various methods, a system, and an article comprising a machine-accessible medium having associated instructions. Other embodiments will be readily apparent to those of ordinary skill in the art. The elements, algorithms, and sequence of operations can all be varied to suit particular requirements.

FIGS. 1 through 7 are merely representational and are not drawn to scale. Certain proportions thereof may be exaggerated, while others may be minimized. FIGS. 1-9 illustrate various embodiments of the invention that can be understood and appropriately carried out by those of ordinary skill in the art.

Although specific embodiments have been illustrated and described herein, it will be appreciated by those of ordinary skill in the art that any arrangement or process that is calculated to achieve the same purpose may be substituted for the specific embodiments shown. This application covers any adaptations or variations of embodiments of the present invention. Therefore, it is manifestly intended that embodiments of this invention be limited only by the claims and the equivalents thereof.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. A method comprising:
displaying a page from a tag-based structure;
detecting a selection of an object of the page; and
storing information to enable subsequent retrieval of the object.

2. The method recited in claim 1 wherein, in storing, the information comprises at least one of a universal resource identifier (URI), an object retrieval string, an access path descriptor, a friendly name, and a runtime object identifier.

3. The method recited in claim 1 wherein displaying further comprises displaying a cursor, and wherein detecting further comprises highlighting the object when the cursor is proximate to the object.

4. The method recited in claim 3 wherein detecting further comprises receiving an actuation signal from a user selection device.

5. The method recited in claim 1 and further comprising:
retrieving a current instantiation of the object without human involvement.

6. The method recited in claim 5 and further comprising:
displaying the retrieved object at a periodic interval without human involvement.

7. A method comprising:
displaying a Hypertext Markup Language (HTML) page on a first device;
detecting a selection of a portion of the HTML page; and
storing information in the first device to enable subsequent retrieval of the portion from a second device.

8. The method recited in claim 7,
wherein, in storing, the information comprises at least one of a universal resource identifier (URI), an object retrieval string, an access path descriptor, a friendly name, and a runtime object identifier.

9. The method recited in claim 7 wherein displaying further comprises displaying a cursor, and wherein detecting further comprises highlighting the portion when the cursor is hovered over the portion.

10. The method recited in claim 9,
wherein, in displaying, the HTML page is displayed on a display screen, and wherein a cursor position is defined by cursor coordinates relative to the display screen; and
wherein, in detecting, the portion is defined on the HTML page by position descriptors, and wherein detecting comprises comparing the cursor coordinates with the portion's position descriptors.

11. The method recited in claim 9 wherein detecting further comprises receiving an actuation signal from a user selection device.

12. The method recited in claim 7 wherein storing further comprises storing a pathway to the portion.

13. The method recited in claim 12 wherein the pathway comprises a Universal Resource Identifier (URI).

14. The method recited in claim 12 wherein the pathway comprises one of a hypertext transfer protocol (HTTP) command, a file transfer protocol (FTP) command, a Java command, and a JavaScript command.

15. The method recited in claim 7 wherein storing further comprises storing a user-assigned name for the portion.

16. The method recited in claim 15 and further comprising:
providing a menu comprising the user-assigned name; and
using the information, including the user-assigned name, to retrieve the portion.

17. The method recited in claim 7 wherein storing further comprises storing a user-designated retrieval interval for the portion.

18. The method recited in claim 7 wherein the portion comprises an HTML object, and the method further comprises:
using the information to retrieve a current instantiation of the portion without human involvement.

19. A method comprising:
storing source information in a device, the source information to enable subsequent retrieval of a unique object from a resource; and
using the source information to retrieve the unique object from the resource.

20. The method recited in claim 19 wherein the resource is one of the Internet, an intranet, a wide area network, a local memory store, and a local area network.

21. The method recited in claim 19 wherein the unique object is a Hypertext Markup Language (HTML) object from an HTML page, and wherein the resource comprises a server on the World-Wide Web.

22. The method recited in claim 19, wherein using comprises searching on the resource by executing a command that includes the source information, and further comprises retrieving a current instantiation of the unique object.

23. The method recited in claim 22 wherein the command comprises one of a hypertext transfer protocol (HTTP) command, a file transfer protocol (FTP) command, a Java command, and a JavaScript command.

24. The method recited in claim 22 and further comprising:
rendering the unique object.

25. The method recited in claim 22 and further comprising:
using the unique object in an application residing in the device.

26. The method recited in claim 19 and further comprising:
immediately displaying the unique object.

27. The method recited in claim 26, wherein the unique object is rendered on the device.

28. The method recited in claim 19 and further comprising:
immediately using the unique object in an application residing in the device.

29. The method recited in claim 19 and further comprising:
formatting the unique object.

30. The method recited in claim 19 wherein the information comprises a user-designated retrieval interval, and wherein using further comprises using the user-designated retrieval interval to retrieve the unique object.

31. The method recited in claim 30 and further comprising:
rendering the unique object.

32. The method recited in claim 31 and further comprising:
using the unique object in an application residing in the device.

33. A system including a display, a memory, and a user interface, the system executing instructions comprising the operations of:
displaying a plurality of objects from a network resource;
receiving, via the user interface, a selection of a selected object from the plurality of objects; and
storing, in the memory, information to enable subsequent retrieval of the selected object by a device without further selection of the selected object from the plurality of objects.

34. The system recited in claim 33 wherein the network resource comprises a Web page, and wherein, in storing, the information comprises at least one of a Web page object identifier, an object position descriptor, an access path descriptor, a friendly name, and a runtime object identifier.

35. The system recited in claim 34 wherein the instructions further comprise the operation of:
retrieving the selected object from the Internet.

36. The system recited in claim 33 wherein the device is a digital appliance, wherein the display forms part of the digital appliance, and wherein the instructions further comprise the operation of:
rendering the selected object.

37. The system recited in claim 33 wherein the instructions further comprise the operation of:
using the selected object in an application residing in the memory.

38. An article comprising a machine-accessible medium having associated instructions, wherein the instructions, when accessed, result in a machine performing:
displaying, on a screen, information comprising a plurality of objects defined in a markup language;
receiving, via a user interface, a selection of a selected object from the plurality of objects; and
storing, in a memory, information to enable subsequent retrieval of future instantiations of the selected object without further selection of the selected object from the plurality of objects.

39. The article recited in claim 38 wherein the instructions, when accessed by the machine, result in the machine performing:
retrieving the selected object from the Internet.

40. The article recited in claim 39 wherein the instructions, when accessed by the machine, result in the machine performing:
rendering the selected object.

41. The article recited in claim 39 wherein the instructions, when accessed by the machine, result in the machine performing:
using the selected object in an application residing in the memory.
